(19) United States
(12) Patent Application Publication
(10) Pub. No.: US 2026/0140980 A1
(43) Pub. Date: May 21, 2026

(54) SOFTWARE AGENTS WITH CONVERSATION HISTORY

(71) Applicant: Google LLC, Mountain View, CA (US)

(72) Inventors: Carsten Isert, Zurich (CH); Patrick Andreas Zoechbauer, Zurich (CH); Nicolas Charles Yves Gros, Aigle (CH); Rhomé François Jean-Baptiste Falaize, Zurich (CH); Hugo Jose Dias Lopes, Zurich (CH); Cristian Pavel, Zurich (CH); Shiqi Chen, New York, NY (US); Manzil Zaheer, West New York, NJ (US); Kavya Venkata Kota Sai Kopparapu, New York, NY (US); Kenneth Daniel Marino, Draper, UT (US); Robert David Fergus, New York, NY (US); Zun Li, New York, NY (US); Nishant Yadav, Jersey City, NJ (US); Ian Song Fischer, Miami Beach, FL (US); Kuang-Huei Lee, San Francisco, CA (US); Veeranjaneyulu Sadhanala, Jersey City, NJ (US); Lauren Haley Beltrone, New York, NY (US); Ricardo Jose Galbis, New York, NY (US); Lei Zhong, Dietlikon (CH)

(21) Appl. No.: 19/394,800

(22) Filed: Nov. 19, 2025

Related U.S. Application Data
(60) Provisional application No. 63/722,561, filed on Nov. 19, 2024.

(51) Int. Cl. G06F 16/3329; G06F 16/3332; G06F 16/34; G06F 40/30

(52) U.S. Cl. CPC G06F 16/33295; G06F 16/3338; G06F 16/345; G06F 40/30

(57) ABSTRACT

Methods, systems, and apparatus, including computer programs encoded on computer storage media, for using conversation histories to augment a software agent. In particular, the software agent can selectively and adaptively be provided with data from conversation history data that comprises respective segment data for each of one or more past segments of each of a plurality of past conversations between a user and a software agent, the respective segment data comprising a respective segment embedding for the past segment.

### CROSS-REFERENCE TO RELATED APPLICATION

This application claims priority to U.S. Provisional Application No. 63/722,561, filed on Nov. 19, 2024. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that generates responses to user queries using a software agent.

In particular, during a current conversation between the software agent and the user, the system can effectively incorporate context from previous conversations between the user and the software agent by making use of a conversation history data store.

The conversation history data store stores information characterizing past segments from past conversations between the user and the software agent.

By selectively incorporating relevant information from the conversation history data store into inputs to the software agent, the system can allow the software agent to generate improved responses to queries that reference or are otherwise relevant to past conversations, without degrading the performance of the software agent on queries that are not relevant to past conversations.

Particular embodiments of the subject matter described in this specification can be implemented so as to realize one or more of the following advantages.

Many user queries to a software agent, e.g., one that interfaces between a user and a set of one or more generative neural networks, can be more effectively processed by incorporating context from previous conversations between the user and the software agent. Examples of such queries include queries that ask to recall specific information from a previous conversation, queries that ask to continue a previous conversation, queries that ask to summarize a previous conversation, and so on.

However, users may have a large number of previous conversations with the software agent and (i) processing all of the turns from all of the previous conversations when generating a response to a current turn may consume an excessive amount of computational resources, e.g., an excessive amount of processor cycles, and cause unacceptable latency and (ii) only a small number of the previous conversations may actually be relevant to the current query. Processing irrelevant previous conversations can decrease response quality while harming computational efficiency. For example, this may be due to the generative neural network employing a self-attention mechanism that (i) has a computational cost that scales quadratically with sequence length and (ii) has the possibility of incorporating irrelevant context through attending to irrelevant portions of the input sequence. Thus, adding irrelevant previous conversations increases the length of inputs to the generative neural network, increasing computational cost, while also potentially harming response quality due to the self-attention layer attending to irrelevant conversations. Moreover, because the list of a given user's conversations grows quickly, it may be difficult for the user to directly identify the relevant conversation to any given query.

The techniques described in this specification address these issues by storing information characterizing past segments from past conversations between the user and the software agent in a conversation history data store and then selectively incorporating relevant information from the data store when responding to queries. Here, “selectively incorporating” refers to (i) only incorporating information from the data store when relevant to generating the current response and (ii) when relevant only incorporating a relatively small fraction of the conversational turns in the data store.

By selectively incorporating relevant information from the conversation history data store into inputs to the software agent, the described techniques can allow the software agent to generate improved responses to queries that reference or are otherwise relevant to past conversations, without degrading the performance of the software agent on queries that are not relevant to past conversations. Moreover, because information from only a small number of relevant queries is incorporated into any given input, the software agent can generate the responses in a computationally-efficient manner, without causing excess latency and without consuming an excessive number of computational resources.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example neural network system.

FIG. 2 is a flow diagram of an example process for generating a response to a query.

FIG. 3 is a flow diagram of an example process for updating the conversation history data.

FIG. 4 shows an example user interface.

Like reference numbers and designations in the various drawings indicate like elements.

### DETAILED DESCRIPTION

This specification generally describes techniques for using, during a current conversation between a user and a software agent, context from past conversations between the user and the software agent to generate responses to queries from the user.

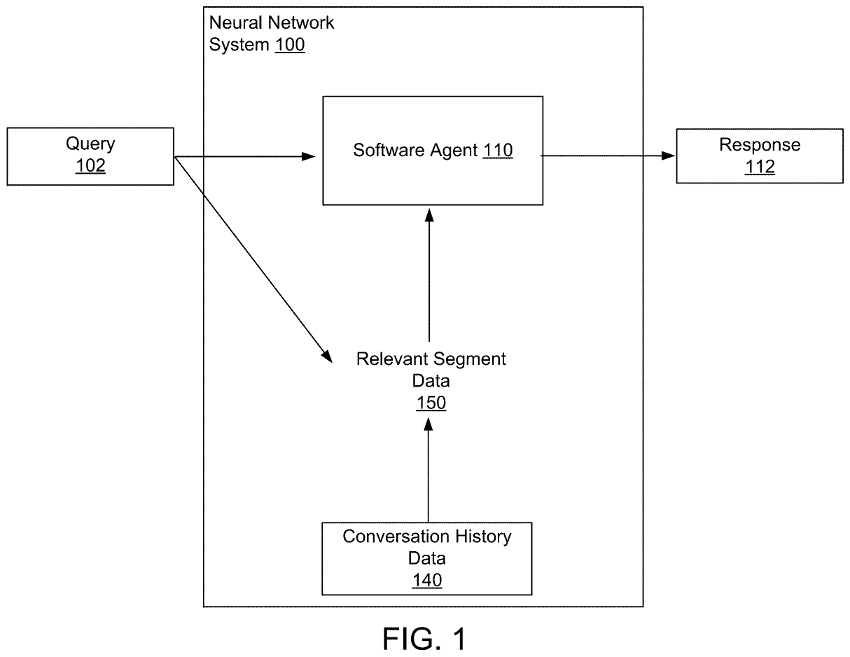

FIG. 1 is a diagram of an example neural network system 100.

The neural network system 100 is an example of a system implemented as computer programs on one or more computers in one or more locations, in which the systems, components, and techniques described below can be implemented.

The neural network system 100 is a system that carries out conversations with one or more users.

Each conversation is a sequence of one or more conversational turns. Generally, each conversational turn is a user query submitted by a user to the system 100 or a response to a user query generated by the system 100 and provided to the user.

In other words, the system 100 implements a software agent 110.

An agent (also known as an “automated assistant,” “personal assistant,” “mobile assistant,” etc.) can be interacted with by a user through a variety of user devices including, e.g., smart phones, tablet computers, wearable devices, automobile systems, standalone personal assistant devices, and so forth.

For example, an agent can receive input from the user including spoken natural language input (i.e., utterances), text inputs, or both, and respond by performing an action, by controlling another device and/or providing responsive content (e.g., visual and/or audible natural language output).

Generally, the software agent 110 is implemented as one or more software programs and uses one or more generative neural networks to respond to user queries during any given conversation.

As one example, the generative neural network(s) can include one or more language model neural networks that process tokens representing text symbols. One or more of these language model neural networks can be multi-modal language model neural networks that can process tokens representing text symbols and tokens representing data of one or more other modalities, e.g., image, video, audio, and so on, or both. As a particular example of the above, a generative neural network can be an auto-regressive neural network that generates the tokens in the output sequence auto-regressively, i.e., one after another. One example of such a neural network is a decoder-only Transformer neural network. Examples of such neural networks include Gemini and Gemma.

Example architectures for the generative neural networks will be described in more detail below.

A given user can have numerous conversations with the software agent 110 over a given period of time. Some conversations are one-off questions (‘When did the Maya and Inca live?’) that are terminated within a single user session with the software agent 110 while other conversations can include multi-session interactions that continue to reference the same topic, e.g., learning, shopping, travel planning, and so on, or that ask for information from previous sessions.

The system 100 can identify which conversation a given query belongs to in any of a variety of ways. For example, the system 100 can present a user interface that allows a user to either (i) start a new conversation by submitting a query that is not associated with any existing conversation or (ii) to select an existing conversation and submit an additional query as part of the existing conversation.

Thus, if a user wants to continue a previous conversation, the user can load the relevant conversation and submit a new query.

However, relying solely on saved conversations becomes increasingly difficult for users because the list of a given user's conversations grows quickly and it may be difficult for the user to directly identify the relevant conversation to any given query. Moreover, needing to manually select the relevant previous conversation to be continued can be time-consuming and otherwise harm the user experience.

To account for this, the system 100 allows the software agent 110 to, when responding to a given user query during a given conversation, access and retrieve information from a user's conversation history, accrued over previous conversations. This allows the system 100 to more effectively surface and provide relevant information in response to any given user query.

In more detail, the system 100 includes the software agent 110 and a conversation history data store 140.

The conversation history data store 140 stores respective segment data for each of one or more past segments of each of a plurality of past conversations between a user and the software agent 110.

Generally, the respective segment data for any given past segment includes a respective segment embedding for the past segment.

A “segment” of a conversation is a sub-sequence of the conversational turns from the conversation.

In some cases, the segment includes less than all of the turns in the conversation while in some other cases, e.g., for shorter conversations, the segment includes all of the turns in the conversation.

An embedding, as used in this specification, is an ordered collection of numerical values, e.g., a vector of floating point or other numerical values.

The system 100 can divide a conversation into segments in any of a variety of ways.

For example, the system 100 can uniformly partition the conversation into fixed-size segments.

As another example, the system 100 can process the conversation using a trained neural network to identify transitions within the conversation and identify each transition as a dividing point between two segments. A “transition” indicates a conversational turn where the topic of the conversation changes. For example, the trained neural network can be a trained language model neural network that is prompted to identify transitions within the input conversation.

For example, the system 100 can generate the respective segment embedding for a given segment by processing an input that includes the respective segment using a segment embedding neural network.

The segment embedding neural network can be any appropriate neural network that can map a set of one or more conversational turns to an embedding. For example, the segment embedding neural network can be a self-attention neural network that has been trained on a representation learning objective, e.g., on a contrastive learning objective, on a masked language modeling objective, or on another appropriate self-supervised objective.

The respective segment data stored in the conversation history data store 140 for any given past segment generally also includes additional information in addition to the respective segment embedding for the past segment.

For example, the respective segment data can also include the segment itself, i.e., include the conversational turns that are part of the segment.

As another example, instead of or in addition to including the segment, the segment data can include a summary, e.g., a natural language summary, of the segment, i.e., of the conversational turns in the segment. For example, the system 100 can process the segment using a language model neural network that is prompted to generate a summary of a set of one or more conversational turns.

As yet another example, the segment data can identify the conversation to which the segment belongs.

As yet another example, the segment data can identify the conversational turns and the index of the conversational turns within the conversation to which the segment belongs.

Thus, for each segment, the conversation history data store 140 stores the segment embedding of the segment and additional information that characterizes the segment.

When the system 100 receives an input query 102 during a current conversation between the user and the software agent 110, the system 100 can determine whether the user query is relevant to one or more of the past conversations that the user has engaged in with the software agent 110.

For example, the system 100 can determine that the user query is relevant to one or more past conversations by processing an input that includes the input query 102 using a language model neural network to generate an output that indicates whether the input query 102 is seeking information relevant to a past conversation. For example, the input can include the input query 102 and a prompt that instructs the language model neural network to analyze whether the input query 102 is seeking information relevant to a past conversation. If the output indicates that the input query 102 is seeking information relevant to past conversation, the system 100 determines the user query is relevant to the one or more past conversations. If the output indicates that the input query 102 is not seeking information relevant to past conversations, the system 100 determines the user query is not relevant to the one or more past conversations.

If the system 100 determines that the query 102 is relevant to one or more of the past conversations that the user has engaged in with the software agent 110, the system 100 can generate, from at least the user query 102, a query embedding.

For example, the system 100 can generate the query embedding by processing an input derived from the user query 102 using a query embedding neural network to generate the query embedding.

In some cases, the input derived from the user query 102 is the user query 102.

As another example, the system 100 can modify the query, e.g., by processing the query using a language model neural network or other machine learning model, to generate a modified form of the input query 102 that is more likely to identify relevant segments. For example, the modified form of the query can be an expanded form of the query, a rewritten form of the query, or a rewritten and expanded form of the query. For example, the system 100 can process the input query 102 using the language model neural network along with a prompt that instructs the language model neural network to add context to the input query 102 or include synonyms or phrases with equivalent meaning to the input query 102.

As a particular example, the query embedding neural network can be the same neural network as the segment embedding neural network or can have been trained jointly with the segment embedding neural network in a dual dense encoder framework, e.g., on a contrastive learning objective.

The system 100 can then select one or more of the past segments of the plurality of past conversations that have embeddings in the data store 140 using the query embedding and the respective segment embeddings, e.g., by identifying the k segment embeddings that are most similar to the query embedding according to cosine similarity, Euclidean distance, or another similarity metric. That is, the system 100 can perform a search of the segment embeddings to identify one or more most relevant past segments that are most relevant to the query embedding. For example, the system 100 can efficiently search the segment embeddings using a kNN or approximate kNN search technique.

The system 100 then generates a response to the user query using the respective segment data for the selected past segments.

In particular, the system 100 can generate an input that includes relevant segment data 150, i.e., the respective segment data for the selected past segments, and the user query 102 and provide the input to the software agent 110.

As described above, the relevant segment data can include any of a variety of data characterizing the corresponding segments.

Thus, the input to the software agent 110 can include any of a variety of data characterizing the selected past segments. For example, the input can include the contents of the selected past segments themselves. As another example, the input can include summaries of the selected past segments.

The software agent 110 can then use the one or more generative neural networks to process the input to generate a response 112 to the query 102.

As a particular example, the software agent 110 can generate, from the respective segment data for the selected past segments and the user query, an input to a language model neural network. The agent 110 can then process the input using the language model neural network to generate an output that includes the response to the user query.

For example, the output can include the response to the user query and a set of tokens specifying one or more past conversations that provide support for the response.

As a particular example, the agent 110 can cause the language model neural network to generate the output by including an appropriate prompt, e.g., a chain of thought prompt or another type of reasoning prompt, in the input to the language model neural network.

The system 100 then provides the response for presentation to the user. Optionally, the system 100 can provide the response for presentation to the user along with data identifying the one or more past conversations that provide support for the response. In some cases, the system 100 provides a link that, when selected by the user, displays the one or more past conversations to the user.

If the system 100 determines that the current query 102 is not relevant to any past conversations, the system 100 can provide the current query 102 as input to the agent 110 without including any relevant segment data.

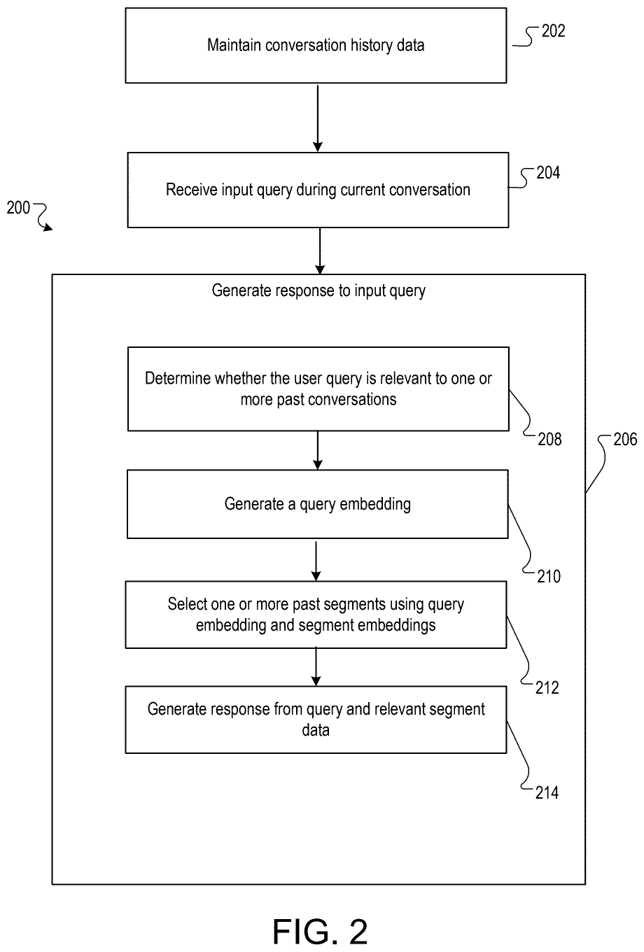

FIG. 2 is a flow diagram of an example process 200 for generating a response to a query. For convenience, the process 200 will be described as being performed by a system of one or more computers located in one or more locations. For example, a neural network system, e.g., the neural network system 100 depicted in FIG. 1, appropriately programmed in accordance with this specification, can perform the process 200.

The system maintains conversation history data (step 202).

As described above, the conversation history data that includes respective segment data for each of one or more past segments of each of a plurality of past conversations between a user and a software agent.

The segment data includes a respective segment embedding for the past segment as well as additional information about the past segment that can be included as input to a generative neural network if the past segment is determined to be relevant to a current query.

The system receives an input query, e.g., a user query from the user, during a current conversation between the user and the software agent (step 204).

The system then generates a response to the input query (step 206).

To generate the response, the system determines whether the user query is relevant to one or more of the past conversations (step 208).

For example, the system can determine that the user query is relevant to one or more past conversations by processing an input that includes the input query using a language model neural network to generate an output that indicates whether the input query is seeking information relevant to a past conversation.

In some cases, the language model neural network is a pre-trained language model neural network and the system causes the neural network to evaluate whether the input query is seeking information relevant to a past conversation by including a prompt that includes a natural language instruction, a few-shot input, or both, as part of the input. In some other cases, in addition to including the prompt, the system or another training system has fine-tuned the language model neural network to improve the performance of the neural network in accurately determining relevance. For example, the system or the other training system can have trained the language model neural network on a training data set that includes a set of example queries and, for each example query, a target output that indicates whether the example query was seeking information about a previous conversation.

If the system determines that the user query is relevant, the system performs steps 210-214 to generate information representing relevant past segments.

For example, the system can determine that queries that ask to continue an earlier conversation are relevant. Examples of such queries include “Tell me more about Hudson Valley, NY architecture” or “I want to continue with my math homework.”

As another example, the system can determine that queries that ask to summarize previous conversations are relevant. Examples of such queries include “Summarize all our previous discussions about my upcoming summer holiday” and “What were the conclusions about our last conversation on the new car purchase?”

As another example, the system can determine that queries that ask to recall specific information mentioned in previous conversations are relevant. Examples of such queries include “What was the restaurant you recommended to me last week?” and “How much was the flight from NYC to ZRH when you searched yesterday?”

If the system determines that the user query is not relevant, the system directly provides the query to the software agent to generate the response without generating any information about any relevant past segments, i.e., without performing steps 210-214.

The system generates, from at least the user query, a query embedding (step 210).

The system selects one or more of the past segments of the plurality of past conversations using the query embedding and the respective segment embeddings (step 212).

The system generates a response to the user query using the respective segment data for the selected past segments (step 214).

In particular, the system can then use one or more generative neural networks to process the input to generate a response to the query.

As a particular example, the system can generate, from the respective segment data for the selected past segments and the user query, an input to a language model neural network. The system can then process the input using the language model neural network to generate an output that includes the response to the user query.

For example, the output can include the response to the user query and a set of tokens specifying one or more past conversations that provide support for the response.

As a particular example, the system can cause the language model neural network to generate the output by including an appropriate prompt, e.g., a chain of thought prompt or another type of reasoning prompt, in the input to the language model neural network.

In some implementations, the prompt can instruct the language model neural network to evaluate whether the retrieved information is sufficient to answer the query and, if not, to issue additional tool calls to obtain additional information. For example, the additional tool calls can include calls to external tools, e.g., search engines or other data repositories, or a call to retrieve additional relevant segments, e.g., with a rewritten form of the user query.

After the response has been generated, the system can provide the response for presentation to the user.

At certain points, the system can update the conversation history data to include segments for the current conversation. For example, the system can update the conversation history data after each new segment of the current conversation is generated, after a user session has ended, or after a threshold amount of time has elapsed since the previous update of the conversation history data.

Updating the conversation history data is described in more detail below.

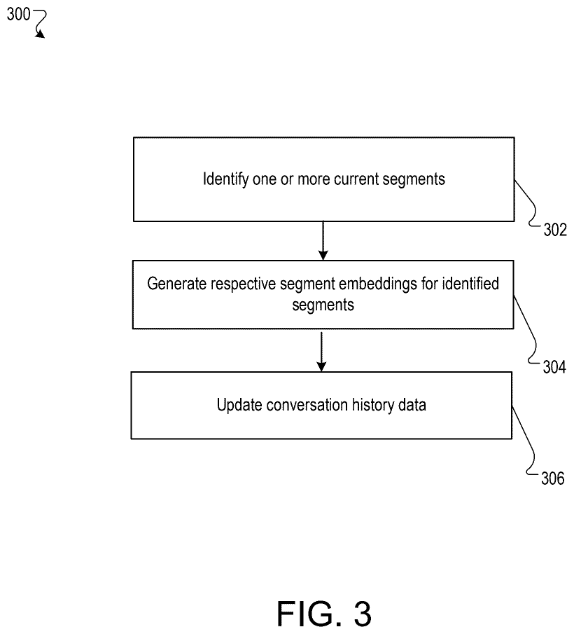

FIG. 3 is a flow diagram of an example process 300 for updating the conversation history data. For convenience, the process 300 will be described as being performed by a system of one or more computers located in one or more locations. For example, a neural network system, e.g., the neural network system 100 depicted in FIG. 1, appropriately programmed in accordance with this specification, can perform the process 300.

In some cases, prior to using the conversation history data, the system initializes the conversation history data by off-line processing past segments of past conversations between the user and the software agent. In some other cases, the system can initialize the conversation history data as empty and can repeatedly update the conversation history data by performing iterations of the process 300.

The system identifies one or more current segments of the current conversation (step 302). For example, the system can identify each segment of the current conversation that is not yet represented in the conversation history data.

As another example, the system can determine, for each segment of the current observation that is not yet represented in the conversation history data, whether to filter out the segment from being stored in the conversation history data. The system can then identify the current segment for inclusion in the conversation history data in response to determining not to filter the current segment.

The system can determine whether to filter a given segment in any of a variety of ways. For example, the system can determine to filter segments that have been designated or have been classified as containing private or other secure information. As another example, the system can determine to filter segments that contain content that has been determined to violate one or more policies for appropriateness or safety.

When the system off-line processes the past segments prior to using the conversation history data, the system can make the same determination for past segments, so that segments are only included in the conversation history data when the system determines not to filter them out.

The system generating a respective segment embedding of each identified segment (step 304). For example, the system can generate the segment embedding using the segment embedding neural network as described above.

The system updates the conversation history data to include the respective segment embeddings of each of the identified segments (step 306). As described above, the system also associates each respective segment embedding with data characterizing the corresponding segment.

In some implementations, the system or the software agent provides users the option to delete previous conversations between the user and the software agent. In these implementations, the system can ensure that segments from deleted conversations are not included in the set of relevant segments for any future queries. In particular, in response to receiving an input indicating that the user has deleted a particular past conversation from a conversation history, the system can remove the respective segment embeddings for each past segment of the particular past conversation from the conversation history data. By removing the segment embeddings for the past segments, the system ensures that the past segments are not selected as relevant segments for future queries.

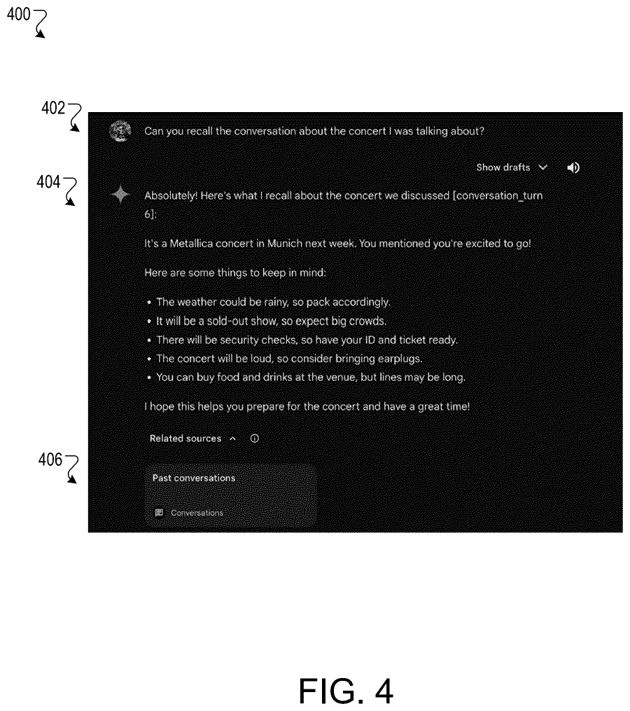

FIG. 4 shows an example 400 of a user interface displaying a query 402 submitted by a user and a response 404 generated by the software agent by making use of relevant segments from the conversation history data store. As can be seen from the example 400, the query 402 asks the software agent for information from a conversation about a concert. In response, the system has accessed relevant segments from the previous conversation using the conversation history data store and has included data characterizing those relevant segments in an input to a generative neural network. The generative neural network then uses the context from those relevant segments to generate the response 404, which directly references a previous conversation (referenced as “conversation_turn 6” in the example for convenience). The user interface also includes a “past conversations” element 410 that, when selected by the user, modifies the user interface to present the segments that the system determined were relevant to the query 402.

An example of architectures for the generative neural networks and language model neural networks now follows. In some cases, the generative neural networks and language model neural networks referred to above all have the same architecture while, in other cases, different ones of the neural networks have different architectures (and, optionally, have been trained differently).

A generative neural network (also referred to simply as a “neural network” or an “attention neural network”) can be configured through training to perform any kind of machine learning task, i.e., can be configured to receive any kind of input sequence and to generate any kind of score, classification, or regression output based on the input sequence.

Generally, the input sequence includes a respective input token at each of a plurality of input positions. That is, the system receives an input sequence and processes the input sequence using the neural network to generate a network output.

The neural network can be configured through training to perform any kind of machine learning task, i.e., can be configured to receive any kind of input sequence and to generate any kind of score, classification, or regression output based on the input sequence.

In some situations, the neural network can be referred to as an auto-regressive neural network, i.e., because the neural network auto-regressively generates an output sequence of tokens. More specifically, the auto-regressively generated output is created by generating each particular token in the output sequence conditioned on a current input sequence that includes at least some of the tokens that precede the particular token in the output sequence, i.e., the tokens that have already been generated for any previous positions in the output sequence that precede the particular position of the particular token. This auto-regressive generation will generally be referred to as auto-regressive decoding.

For example, the neural network can be an auto-regressive attention neural network that includes (i) a plurality of attention blocks that each apply a self-attention operation and (ii) an output subnetwork that processes an output of the last attention block to generate the score distribution, e.g., a score distribution used for selecting an output token, e.g., by sampling from the score distribution or selecting a most likely token according to the score distribution.

In this example, the neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; Gemini Team, et al. Gemini 1.5: Unlocking multimodal understanding across millions of tokens of context. arXiv preprint arXiv:2403.05530 (2024); and Comanici, Gheorghe, et al. Gemini 2.5: Pushing the frontier with advanced reasoning, multimodality, long context, and next generation agentic capabilities. arXiv preprint arXiv:2507.06261 (2025), Gemma Team, et al. Gemma 3 Technical Report arXiv preprint arXiv:2503.19786 (2025).

More specifically, the neural network includes a plurality of layers that include a plurality of self-attention layers.

Each attention layer receives a respective hidden state for each of the input positions in the input sequence and updates the respective hidden states for each of the input positions by applying a self-attention attention mechanism to the respective hidden states. That is, each hidden state corresponds to a respective input token within the input sequence, i.e., the hidden state for a given input position corresponds to the token at the given input position.

For the first attention layer in the neural network, the respective hidden states can be the input tokens in the input sequence or the input tokens after having been modified by one or more initial layers of the neural network. For the subsequent attention layers in the sequence, the respective hidden states can be the outputs of a preceding layer within the attention neural network.

The attention layers can include global attention layers, local attention layers, or both.

Each global attention layer applies a global attention mechanism that, for each of the plurality of input positions, attends over all of the input positions preceding or equal to the input position in the input sequence.

The global attention mechanisms applied by the global attention layers can be dense attention mechanisms or sparse attention mechanisms.

A “dense” attention mechanism is one that, for any given input position, assigns non-zero attention weights to (at least) a large proportion of the input positions preceding or equal to the given input position in the input sequence. For example, a majority of the attention weights may be non-zero, 90% of the weights may be non-zero, or all of the weights may be non-zero.

A “sparse” attention mechanism is one that, for any given input position, is constrained to only assign non-zero attention weights to a relatively small proportion of the input positions preceding or equal to the given input position in the input sequence. For example, in a sparse attention mechanism, a majority of the attention weights may be zero.

Each local attention layer, on the other hand, applies a local attention mechanism that, for each of the plurality of input positions, attends only over a set of local input positions that are within a local window of the input position in the input sequence.

That is, unlike the global attention mechanisms, the local attention mechanism does not attend to any position that is outside of the local window of the input position.

The local windows are generally “causal,” so that, for any given input position, they include up to a fixed number of input positions that are closest to the given input position and that precede or are equal to the given input position, but not any input positions that are after the given input position in the input sequence.

The fixed number of input positions is generally much smaller than the total number of positions in the input sequence and is referred to as the size of the context window.

Optionally, some or all of the attention layers can apply position encoding.

“Position encoding” refers to modifying the operations applied by the attention layer for a given input position based on the absolute or relative position of the input position within the input sequence.

For example, the position encoding can be Rotary Position Embedding (RoPE) position encoding or a different type of position encoding, e.g., an Attention with Linear Biases (ALiBi) position encoding.

In general, applying position encoding at an attention layer rather than applying position encoding, e.g., at the neural network input, or not applying position encoding involves using additional information at the attention layer that identifies the relative or absolute positions of hidden states that are received as input by the attention layer. The position of a hidden state generally refers to the input position within the input sequence of the input token to which the hidden state corresponds.

Generally, to apply the self-attention operation, each attention mechanism uses one or more attention heads.

Each attention head generates a set of queries, a set of keys, and a set of values, and then applies any of a variety of variants of query-key-value (QKV) attention, e.g., a dot product attention function or a scaled dot product attention function, using the queries, keys, and values to generate an output.

As a particular example, in an attention head (also referred to as a “self-attention head”) of a self-attention neural network layer, the attention mechanism may be configured to apply each of a query transformation, e.g., defined by a matrix W^{Q}, a key transformation, e.g., defined by a matrix W^{K}, and a value transformation, e.g., defined by a matrix W^{V}, to the attention layer input for each hidden state of an input sequence X to derive a respective query vector Q=XW^{Q}, key vector K=XW^{K}, and value vector V=XW^{V} which are used determine the updated hidden state. For example, the attention head can generate an updated hidden state for each input position computing a weighted sum of the values, weighted by a similarity function of the query for the input position to the corresponding key. The similarity function may comprise, e.g., a dot product, cosine similarity, or other similarity measure.

When the attention head uses position encoding, the application of the dot product attention function, the computation of the queries, keys, and values, or both depend on the relative or absolute positions of the hidden states corresponding to the queries, keys, and values within the input sequence.

For example, an implementation of RoPE can involve determining, for a given query at a respective input position, a query rotation matrix that represents the absolute or relative position of the respective input position of the query, e.g., an index of the input position in the sequence; determining, for a given key at a respective input position, a key rotation matrix that similarly represents the absolute or relative position of the respective input position of the key, e.g., an index of the input position in the sequence, and multiplicatively combining the query rotation matrix, the key rotation matrix, the query (vector), and the key (vector), to determine a weight value between the query and the key that is dependent on a relative distance between the position corresponding to the key and the position corresponding to the query.

As another example, an implementation of ALiBi can involve adding a linear bias matrix to a weight determined from a combination of the key and the query.

When the attention head does not use position encoding, both the application of the dot product attention function and the computation of the queries, keys, and values, are independent of the relative or absolute positions of the hidden states corresponding to the queries, keys, and values within the input sequence.

Each query, key, and value can be a vector that includes one or more vector elements. When there are multiple attention heads, the attention block then combines the outputs of the multiple attention heads, e.g., by concatenating the outputs and, optionally, processing the concatenated outputs through a linear layer.

For local attention mechanisms, for each position, the positions that are used to generate the queries, keys, and values for the position are defined by the local window size for the local attention mechanism, i.e., non-zero attention weights for a given position are computed only for positions that are within the local window of the given position.

In some cases, because the attention applied by the attention layers is causal, the system can store, for any given attention mechanism and when generating the output for any given input position, the hidden states or the keys and values already computed for earlier input positions steps rather than re-computing the hidden states (or the keys and values) for earlier time steps.

Thus, in these cases, updating the respective hidden states for each of the input positions by applying an attention mechanism to the respective hidden states refers to updating the respective hidden state for the last input position in the current input sequence using keys and values or hidden states for the other input positions that have been retrieved from memory (e.g., from a “cache”). Storing keys and values in a memory for later re-use will generally be referred to as storing the keys and values in a “KV cache.”

The layers in the neural network can also include other types of layers, e.g., normalization layers, residual connection layers, feedforward layers, and so on.

In some cases, some or all of the feedforward layers in the neural network are implemented as sparse mixture of experts (MoE) layers while in other cases all the feedforward layers are dense feedforward layers.

A MoE layer may be one that includes multiple “experts”, each expert including one or more neural network layers, e.g., feedforward layers.

A MoE layer is generally equipped with a router that routes an input to the MoE layer, e.g., each hidden state in a set of hidden states received by the MoE layer, to one or more selected experts, with the output of the MoE layer for a given input being generated by combining the outputs generated by the selected experts or, when there is only one selected expert, using the output of the selected expert as the output. The MoE layer can optionally be followed by a normalization layer, a residual connection layer, or both,

A sparse MoE layer is one in which the router routes any given input to only a small fraction, e.g., less than half, of the experts, so that only a small fraction of experts is active for the processing of any given input.

More particularly a method as described herein can be performed on a combination of a host processor, such as a general-purpose computing system, and one or more hardware neural network accelerators, such as one or more TPUs, GPUs, or other machine learning accelerators. Typically, such accelerators include hardware to perform matrix multiplication and memory, although this may be less than the memory capacity of the host processor.

In some implementations, the system performs the processing of an input sequence using the attention neural network by making use of a combination of a host processor, such as a general-purpose computing system that includes one or more CPUs, and one or more hardware neural network accelerators, such as one or more TPUs, GPUs, or other machine learning accelerators. Typically, such accelerators include hardware to perform matrix multiplication and memory (“on-chip memory”). The memory capacity of the on-chip memory is generally less than the memory capacity of the host processor (“off-chip memory”).

As an example of how the system can use the combination of the host processor and the one or more accelerators, the system can load values for a set of weights or other learned parameters for the neural network, from the host processor into memory of the one or more hardware accelerators. The input sequence is then processed using the plurality of attention layers, each implemented on the one or more hardware accelerators, (and using the other layers in the neural network, if any) to generate a network output. For example, the network output can include an auto-regressively generated output sequence in which each particular output token in the output sequence is conditioned on a current input sequence that includes at least some of the output tokens that precede the particular token in the output sequence.

During processing of the input sequence, a KV cache is maintained for some or all of the attention layers on the one or more hardware accelerators, by the host processor, or both. That is, the KV cache can be maintained in memory that includes on-chip memory, off-chip memory, or that is distributed across both on-chip and off-chip memory.

The KV cache includes stored keys and values generated by the attention heads of (the) some or all of the plurality of attention layers, for use in applying an attention mechanism of an attention layer (or layers) to a respective hidden state input to update the respective hidden state for a last input position in the current input sequence.

When the KV cache is maintained on the hardware accelerators, i.e., in on-chip memory, because the described techniques enable use of KV cache with reduced size due to more effective quantization, the KV cache needs to store fewer keys and values, thereby consuming less of the limited memory capacity of the on-chip memory and, in some cases, allowing the KV cache to fit in on-chip memory (when KV caches generated using conventional approaches could not fit).

When the KV cache is maintained on the host computer, e.g., because the KV cache cannot fit in on-chip memory, because the described techniques enable storage of a smaller amount of data given the same number of tokens, the KV cache needs to store less data, thereby reducing the amount of off-chip data that needs to be transmitted on-chip in order to perform the processing of the neural network, i.e., thereby consuming less of the available data communication bandwidth.

In general, in implementations of the described techniques the input data, e.g., text, audio, and/or an image or video, may be encoded into a sequence of input tokens in any convenient manner; and output tokens may be similarly decoded into text, audio, and/or image or video data according to the particular task or tasks to be performed.

In other words, the neural network may be a language model or vision language model neural network. In general, a (vision) language model neural network can be a neural network that has been trained so that, given a text prompt that includes a sequence of tokens in a natural language, the neural network can generate the next token in the sequence. This process can be repeated to extend the text prompt one token at a time to generate a natural language output, i.e., to generate the natural language output auto-regressively token by token. At each time “time step,” the language model neural network processes the current sequence to generate a probability distribution over a vocabulary of tokens. The next token can then be selected using the probability distribution, e.g., by sampling from the distribution using nucleus sampling or another sampling technique or by selecting the highest-probability token. The tokens in the vocabulary can include any of a variety of tokens, e.g., some combination of words, sub-words, characters, punctuation and other symbols, and numbers. In general, the language model neural network is trained on a corpus of text made up of tokens from the vocabulary (and optionally other tokens that can be mapped to a designated out-of-vocabulary token), to predict the next token in a sequence of tokens from the training data. The (vision) language model neural network can comprise an autoregressive Transformer neural network.

A (vision) language model neural network can be made to perform a particular task by providing a natural language description of the desired response as an input or “prompt” (input sequence). In some cases, the prompt may be a few-shot prompt where a few, e.g., 1 to 10, examples of a query and an example output are provided in the text prior to the actual query.

Instead or in addition, a (vision) language model neural network may be “fine-tuned” to perform a particular task, by obtaining a pre-trained language model neural network trained on a large corpus of examples as previously described and then further training part of all of the language model neural network on a relatively small number of examples particular to the type of task that is to be performed.

The (vision) language model neural network may be a large language model neural network, e.g., one that has greater than 1 billion, 10 billion or 100 billion trained parameters. The (vision) language model neural network may have been trained on greater than 10 billion, 100 billion or 1000 billion words or tokens representing words or other tokens.

### Tokens

In implementations the model input and the model output (and the training sequences) each comprise a sequence of elements referred to herein as tokens. A “token” as used in this specification is a vector of numerical values having a specified dimensionality, i.e., the number of numerical values is constant across different tokens. Each token can comprise a respective predetermined or learned embedding (an ordered collection of numerical values having a predetermined dimensionality).

The neural network can have a sequence processing architecture, in which the model input comprises an input sequence of tokens and the model is configured to generate an output comprising an output sequence of tokens. The neural network can be a generative neural network system configured to process the input sequence of tokens using a sequence processing neural network to generate the output sequence of tokens.

In some implementations the tokens can represent text, e.g., words, wordpieces or characters, in a natural or computer language. For example, text may be received, e.g., as a series of encoded characters, e.g., UTF-8 encoded characters; such “characters” can include Chinese and other similar characters, as well as logograms, syllabograms and the like. A text encoder, i.e., a tokenizer, can process a sequence of text to represent the text as a series of text tokens from a vocabulary of text tokens, e.g., that each represent words, wordpieces or characters in a natural or computer language. The computer language may be any formal language used to communicate with a computer, e.g., a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens may be converted into audio data that represent speech corresponding to the text.

Also or instead the tokens may represent an image. For example, a set (sequence) of input or output tokens can represent an image. Each image token may comprise a block encoding of values of the pixels in a different region of an image that maps a set of values of the pixels to a respective image token. The block encoding may be obtained using a neural network such as a Transformer neural network.

As used herein an image may be any still or moving image, i.e., the image may be part of a video, in 2D or 3D, and may be a monochrome, color or hyperspectral image, i.e., comprising monochrome or color pixels. As defined herein an “image” includes a point cloud, e.g., from a LIDAR system, and a “pixel” includes a point of the point cloud. An image may have been captured by a camera or other image sensor from the real world; and objects in the image may comprise physical objects, represented by the image.

Also or instead the tokens may represent an audio waveform. For example, a set (sequence) of input or output tokens can represent audio data representing a waveform e.g., instantaneous audio amplitude values or time-frequency audio data. Each image token may comprise a block encoding of the audio waveform in a different time segment of the audio that maps a set of values representing the audio waveform to a respective image token. The block encoding may be obtained using a neural network such as a Transformer neural network.

In a multimodal system audio data or an image may be flagged by a start-of-audio token or start-of-image token.

A trained version of the neural network can be obtained in any convenient manner. Merely as an example a sequence processing neural network model can be trained using a token-predicting objective or other, such as a softmax cross entropy loss (with teacher forcing) or an autoregressive negative log likelihood (NLL) loss. As an example such a loss could be

$$- {{\sum }_{l = 1}}^{L} log p ( {y}_{l} ⋁ {y}_{¿ 1} , {x}_{\leq 1} )$$

for an input comprising a sequence of L tokens with the lth token yₗ conditioned on preceding inputs x_{≤l}, and conditioned on preceding tokens y_{¿l}. As another example the model could be trained with a masking loss, e.g., a loss that requires the model to predict masked-out data such as masked out text or image tokens.

There are many suitable training datasets available, depending on the task to be performed. Just as some examples these include: WebLI (Web Language Image, Chen et al. arXiv:2305.18565v1); Open Images V4 (Kuznetsova et al., arXiv:1811.00982); Conceptual Captions (Sharma et al., “Conceptual Captions: A Cleaned, Hypernymed, Image Alt-text Dataset For Automatic Image Captioning”, ACL 2018); Kinetics (Kay et al., arXiv:1705.06950); for audio, AudioSet (Gemmeke et al., “Audio set: An ontology and human-labeled dataset for audio events,” ICASSP, IEEE, 2017, pp. 776-780); for robot control Bridgedata v2 (Walke, et al., “Bridgedata v2: A dataset for robot learning at scale.” Conference on Robot Learning. PMLR, 2023).

In general, a training dataset for a particular task may comprise task-specific training examples that have been manually generated by a human being and/or task-specific training data may be generated automatically using existing tools. For example an OCR (Optical Character Recognition) task dataset may be generated by applying an OCR tool to a corpus of images; or an object detection task that requires generating object bounding-box coordinates may be generated by applying an existing object detection tool, such as a trained neural network, to a corpus of images; or a set of aligned image and text representations may be generated using ALIGN (Jia, et al., arXiv:2102.05918); or instruction-annotated robot trajectories may be obtained as described in Brohan, et al., arXiv:2212.06817, in either the real-world or in simulation.

### Example Hardware Implementations

As previously described, implementations of the described techniques can use a (trained) generative neural network system.

In some implementations the generative neural network system, e.g., a language model or a visual language model, is stored on a user computing device, i.e., a device local to the user, such as a mobile device, e.g., a mobile phone, or a smart speaker.

In some implementations the generative neural network system is implemented on a remote server in communication with a user computing device over a wired or wireless network communications link between the user computing device and the server.

The user computing device may be provided with an input mechanism, such as a text or voice interface, that enables user input from the user in a natural language. The user computing device may be provided with an output mechanism that provides a system output for the user in the or another natural language, e.g., as speech or text; or in some other way, e.g., by displaying an image. The input and output mechanism may comprise, e.g., a keyboard, microphone, speaker, display, and/or camera.

As an example, the input mechanism may comprise a system configured to input audio data characterizing a speech waveform of speech representing the input from the user in a natural language and configured to convert the audio data into tokens representing the speech in the natural language, e.g., representing a transcription of the spoken input. The output mechanism may comprise a system configured to receive tokens representing the output for the user in the or another natural language and a system configured to convert the received tokens into audio data representing a waveform of speech representing the output to the user in the natural language, i.e., representing spoken words.

As a further example, the trained system can be deployed in an environment that enables a user to provide a request for the system, e.g., to process a multimodal input to generate a corresponding output sequence output. A user can provide the request, e.g., by way of a user interface or through an application programming interface (API). The request can be transmitted from a user device, e.g., over a data communications network such as the internet, to one or more computers implementing the system, e.g., in a data center. The system can generate an output sequence and then transmit the output sequence to a user device over a data communications network.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
maintaining conversation history data that comprises respective segment data for each of one or more past segments of each of a plurality of past conversations between a user and a software agent, the respective segment data comprising a respective segment embedding for the past segment;
during a current conversation between the user and the software agent:
receiving a user query from the user;
determining that the user query is relevant to one or more of the past conversations;
in response:
generating, from at least the user query, a query embedding;
selecting one or more of the past segments of the plurality of past conversations using the query embedding and the respective segment embeddings;
generating a response to the user query using the respective segment data for the selected past segments; and
providing the response for presentation to the user.

2. The method of claim 1, further comprising:
for each of the one or more past segments, generating the respective segment embedding by processing an input comprising the respective segment embedding using a segment embedding neural network.

3. The method of claim 1, further comprising:
prior to adding the respective segment embedding for each of the one or more past segments, determining whether to filter out the past segment from being stored in the conversation history data.

4. The method of claim 1, wherein generating, from at least the user query, a query embedding comprises:
processing an input derived from the user query using a query embedding neural network to generate the query embedding.

5. The method of claim 4, wherein generating, from at least the user query, a query embedding further comprising:
generating, from the user query, the input derived from the user query.

6. The method of claim 5, wherein generating, from the user query, the input derived from the user query comprises:
generating a modified query that is a rewrite or an expanded form of the query.

7. The method of claim 1, further comprising:
receiving an input indicating that the user has deleted a particular past conversation from a conversation history; and
in response, removing the respective segment embeddings for each of the one or more past segments of the particular past conversation from the conversation history data.

8. The method of claim 1, wherein the respective segment data comprises the past segment.

9. The method of claim 1, wherein the respective segment data comprises a summary of the past segment.

10. The method of claim 1, wherein the respective segment data comprises data identifying the respective past conversation to which the past segment belongs.

11. The method of claim 8, wherein the respective segment data comprises data identifying one or more conversational turns from the respective past conversation to which the past segment belongs that are included in the segment.

12. The method of claim 1, wherein determining that the user query is relevant to one or more of the past conversations comprises:
processing an input comprising the user query using a first language model neural network to generate an output that indicates whether the user query is seeking information relevant to a past conversation.

13. The method of claim 1, wherein generating a response to the user query using the respective segment data for the selected past segments comprises:
generating, from the respective segment data for the selected past segments and the user query, a second input to a second language model neural network; and
processing the second input using the second language model neural network to generate an output comprising the response to the user query.

14. The method of claim 13, wherein the output comprising the response to the user query response to the user query further comprises a set of tokens specifying one or more past conversations that provide support for the response.

15. The method of claim 14, wherein providing the response for presentation to the user comprises:
providing the response for presentation to the user along with the data identifying the one or more past conversations that provide support for the response.

16. The method of claim 15, wherein providing the response for presentation to the user along with the data identifying the one or more past conversations that provide support for the response comprises:
providing a link that, when selected by the user, displays the one or more past conversations to the user.

17. The method of claim 1, further comprising:
identifying one or more current segments of the current conversation;
generating a respective segment embedding of each identified segment; and
updating the conversation history data to include the respective segment embeddings of each of the identified segments.

18. A system comprising one or more computers and one or more storage devices storing instructions that when executed by the one or more computers cause the one more computers to perform operations comprising:
maintaining conversation history data that comprises respective segment data for each of one or more past segments of each of a plurality of past conversations between a user and a software agent, the respective segment data comprising a respective segment embedding for the past segment;
during a current conversation between the user and the software agent:
receiving a user query from the user;
determining that the user query is relevant to one or more of the past conversations;
in response:
generating, from at least the user query, a query embedding;
selecting one or more of the past segments of the plurality of past conversations using the query embedding and the respective segment embeddings;
generating a response to the user query using the respective segment data for the selected past segments; and
providing the response for presentation to the user.

19. The system of claim 18, the operations further comprising:
for each of the one or more past segments, generating the respective segment embedding by processing an input comprising the respective segment embedding using a segment embedding neural network.

20. One or more non-transitory computer storage media storing instructions that when executed by one or more computers cause the one more computers to perform operations comprising:
maintaining conversation history data that comprises respective segment data for each of one or more past segments of each of a plurality of past conversations between a user and a software agent, the respective segment data comprising a respective segment embedding for the past segment;
during a current conversation between the user and the software agent:
receiving a user query from the user;
determining that the user query is relevant to one or more of the past conversations;
in response:
generating, from at least the user query, a query embedding;
selecting one or more of the past segments of the plurality of past conversations using the query embedding and the respective segment embeddings;
generating a response to the user query using the respective segment data for the selected past segments; and
providing the response for presentation to the user.
